(19) United States
(12) Patent Application Publication
(10) Pub. No.: US 2008/0270305 A1
(43) Pub. Date: Oct. 30, 2008

(54) Validation of queue tickets in wireless communications terminals by near-field communicatons with ticket machines

(75) Inventors: Mans Folke Markus Andreasson, Lund (SE); Erik Johan Vendel Backlund, Lund (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/789,380

(22) Filed: Apr. 24, 2007

(51) Int. Cl. G06Q 10/00

(52) U.S. Cl. 705/50; 455/566; 455/73; 705/1

(57) ABSTRACT

Methods, wireless communication terminals, and queue management system are disclosed that operate electronically accessible queues, such as customer service queues. A wireless communications terminal is used to obtain a queue ticket from a ticket machine. The queue ticket indicates that a ticket client has been entered a queue associated with the ticket machine. The queue ticket is stored in the wireless terminal. The queue ticket in the wireless terminal is validated via a near-field communications protocol wireless interface between the wireless terminal and the ticket machine. Service for the ticket client is authorized in response to validation of the queue ticket and movement of the ticket client to a threshold level within the queue.

### BACKGROUND OF THE INVENTION

The present invention relates to managing the provision of services via queues, and, more particularly, to methods, wireless terminals, and systems for managing queues.

Waiting in queues has unfortunately become a common occurrence as businesses attempt to manage access to their services in an equitable manner. A few typical examples of where customer/client queues are often found include restaurants, amusement/theme parks, museums, and car repair/service centers. Customers typically perceive waiting in a queue as being a frustrating and unproductive use of their time, and the presence of a group of waiting customers can detract from the aesthetics and efficiency of a business.

A person generally enters a queue by arriving at the premises of a business and entering a name following the last entry already recorded in the queue. The person then does not generally feel free to physically leave the premises out of a concern of losing his place in the queue if not present when his name reaches the top of the queue.

Some alternatives offered by businesses are to call the business to make a reservation for a mutually agreed-upon date and time, or to call ahead when departing for a business to request the person's name be entered in the queue. Such reservations and/or call-ahead processes may be inconvenient and time-consuming for both the customer and business. Moreover, the phone-in process is inherently serialized and does not lend itself to allowing the customer to easily determine the length of queues at many other businesses so as to more flexibly balance the customer's time and interests.

### SUMMARY OF THE INVENTION

Some embodiments of the present invention are directed to methods of operating electronically accessible queues, such as customer service queues. A wireless communications terminal is used to obtain a queue ticket from a ticket machine. The queue ticket indicates that a ticket client has been entered a queue associated with the ticket machine. The queue ticket is stored in the wireless terminal. The queue ticket in the wireless terminal is validated via a near-field communications protocol wireless interface between the wireless terminal and the ticket machine. Service for the ticket client is authorized in response to validation of the queue ticket and movement of the ticket client to a threshold level within the queue.

In some further embodiments, the queue ticket may be obtained by the wireless terminal by communicating a queue request from the wireless terminal through the Internet to the ticket machine, entering the ticket client into the queue, and communicating the queue ticket from the ticket machine through the Internet to the wireless terminal. The queue request may be communicated from the wireless terminal to the Internet via a far-field communications protocol air interface, such as a cellular protocol air interface, a WiMAX communications protocol air interface, and/or a HIPERMAN communications protocol air interface.

In some further embodiments, a determination is made as to how many entries for the ticket client are present in the queue. The ticket machine communicates a denial of queue ticket response to the wireless terminal in response to the determined number of entries exceeding a threshold number. The wireless terminal may communicating a queue ticket release command to the ticket machine to remove the ticket client from the queue.

In some further embodiments, a queue search query may be communicated from the wireless communications terminal through the Internet to a queue server. The queue server communicates a queue response from the queue server through the Internet to the wireless communications terminal. The queue request communicated from the wireless communications terminal to the ticket machine is carried out based on information contained in the queue response from the queue server. The queue search query generated from the wireless communications terminal may identify a business name and/or a business category, and the queue response communicated from the queue server may contain information that identifies what queues, if any, are associated with the business name and/or the business category identified by the queue search query.

In some further embodiments, the queue ticket may be validated by communicating the queue ticket from the wireless communications terminal to the ticket machine via a radio frequency identification (RF ID) communications protocol air interface, a Bluetooth communications protocol air interface, and/or a wireless local area network (WLAN) communications protocol air interface. The ticket machine may then validate the received queue ticket.

In some further embodiments, the ticket machine at least partially encrypts the queue ticket that it communicates to the wireless terminal. The ticket machine then validates the queue ticket stored in the wireless terminal by receiving the queue ticket from the wireless terminal via the near-field communications protocol air interface, decrypting the encrypted portion of the queue ticket, and determining whether the queue ticket is valid in response to the decryption.

Some other embodiments of the present invention are directed to a wireless communication terminals. A wireless communication terminal may include a near-field communications protocol transceiver and a ticket client. The near-field communications protocol transceiver is configured to communicate via a near-field communications protocol with one or more communication devices. The ticket client is configured to store a queue ticket obtained from a ticket machine, where the queue ticket indicates entry of the ticket client into a queue associated with the ticket machine, and is configured to communicate the queue ticket to the ticket machine through the near-field communications protocol transceiver.

In some further embodiments, the wireless terminal further includes a far-field communications protocol transceiver that is configured to communicate via a far-field communications protocol to an Internet service provider connected to the ticket machine. The ticket client is further configured to transmit a queue request through the far-field communications protocol transceiver and the Internet to the ticket machine, and to receive the queue ticket from the ticket machine through the far-field communications protocol transceiver.

In some further embodiments, the near-field communications protocol transceiver may be configured to communicate according to a radio frequency identification (RF ID) communications protocol, a Bluetooth communications protocol, and/or a wireless local area network (WLAN) communications protocol. The far-field communications protocol transceiver may be configured to communicate according to a cellular protocol, a WiMAX communications protocol, and/or a HIPERMAN communications protocol.

In some further embodiments, the near-field communications protocol transceiver is configured to detect presence of the ticket client within its communication range, and the ticket client is further configured to communicate the queue ticket to the ticket machine via the near-field communications protocol transceiver in response to detecting presence of the ticket client.

In some further embodiments, the ticket client is further configured to generate a queue search query that identifies a business name and/or a business category and which is transmitted through the far-field communications protocol transceiver to a queue server. The ticket client receives a queue response from the queue server via the far-field communications protocol transceiver, where the queue response identifies which queues, if any, are associated with the business name and/or the business category identified by the queue search query. The ticket client displays information that is indicative of the queues identified by the queue response.

In some further embodiments, the ticket client is further configured to detect a user selection of one of the queues identified by the queue response, and to generate a queue request that identifies the user selected queue and which is transmitted through the far-field communications protocol transceiver to the ticket machine.

Some other embodiments of the present invention are directed to queue management system. The queue management system may include a ticket machine that is configured to enter a ticket client into a queue, to communicate a queue ticket across the Internet to the ticket client hosted on a wireless terminal indicating entry of the ticket client into the queue, to validate the queue ticket stored in the wireless communications terminal via a near-field communications protocol air interface between the wireless communications terminal and the ticket machine, and to authorize service associated with the ticket client in response to validation of the queue ticket and movement of the ticket client to a threshold level within the queue.

In some further embodiments, the queue management system may further include a queue server that is configured to receive from the ticket client via the Internet a queue search query that identifies a business name and/or a business category, configured to communication a queue response to the ticket client via the Internet that identifies what queues, if any, are associated with the business name and/or the business category identified by the queue search query, wherein the queue response is used by the ticket client to generate a queue request that identifies one of the queues where entry is requested.

In some further embodiments, the ticket machine is further configured to encrypt at least a portion of the queue ticket communicated to the ticket client, and to validate the queue ticket received back from the ticket client by decrypting the encrypted portion of the queue ticket and determining whether the queue ticket is valid in response to the decryption.

In some further embodiments, the ticket machine includes a near-field communications protocol transceiver that is configured to receive the queue ticket from the ticket client hosted on the wireless communication device via a radio frequency identification (RF ID) communications protocol wireless interface, a Bluetooth communications protocol wireless interface, and/or a wireless local area network (WLAN) communications protocol interface.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram of a queue management system in accordance with some embodiments of the present invention;

FIG. 2 is a is a block diagram that illustrates further detail of a portion of the queue management system of FIG. 1 in accordance with some embodiments of the present invention;

FIG. 3 is a message flow diagram that illustrates operations and methods for searching for an electronically accessible queue, entering the queue, and obtaining a queue ticket via a ticket client on a wireless communication terminal in accordance with some embodiments of the present invention;

FIG. 4 is a message flow diagram that illustrates operations and methods for obtaining queue status information via a ticket client on a wireless communication terminal in accordance with some embodiments of the present invention;

FIG. 5 is a message flow diagram that illustrates operations and methods for activating a queue ticket via a ticket client on a wireless communication terminal and authorizing service upon satisfying a queue in accordance with some embodiments of the present invention; and

FIG. 6 is a message flow diagram that illustrates operations and methods for releasing a queue ticket via a ticket client on a wireless communication terminal in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” and its abbreviation “/”, include any and all combinations of one or more of the associated listed items.

The present invention is described below with reference to block diagrams and/or operational illustrations of apparatus, methods, and computer program products according to embodiments. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: a portable computer diskette, a random access memory (RAM), a read-only memory (ROM), an erasable programmable read-only memory (EPROM or Flash memory), and a compact disc read-only memory (CD-ROM).

In accordance with some embodiments of the present invention, a person may operate a wireless communications terminal (hereinafter “wireless terminal”) to electronically access and be added to a queue, and to obtain a queue ticket (e.g., electronic receipt). The queue may be electronically accessed and the queue ticket may be communicated to the wireless terminal using far-field wireless communications, such as cellular communications. The queue ticket indicates that a ticket client, which is associated with the person, has been entered into the queue. The queue ticket is electronically stored in the wireless terminal and can be later validated through near-field wireless communications between the wireless terminal and a ticket machine. The person may then be authorized to obtain services in response to the queue ticket being validated and in response to movement of the ticket client to a threshold level within the queue, such as moving to the top of the queue as other ticket clients are serviced.

For example, a person may use a wireless terminal to remotely access a queue across a cellular wireless communications link and the Internet to obtain a queue ticket, which is then stored in the wireless terminal. Upon arriving in the vicinity of a business having the queue, the queue ticket can be validated using near-field communications according to a radio frequency identification (RF ID) protocol, a Bluetooth protocol, and/or a wireless local area network (WLAN) protocol (e.g., IEEE 802.11). The business is thereby notified that the person is now proximately located to the business and is therefore available to receive services upon satisfying the queue.

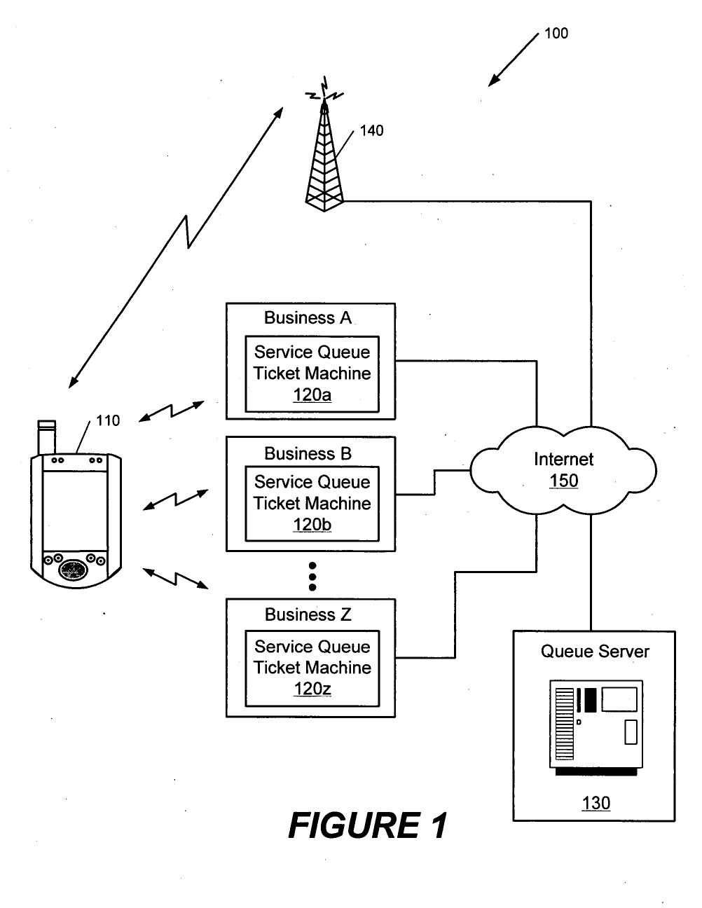

Some embodiments of the invention will now be described with regard to FIG. 1, which is a block diagram of a queue management system 100 that is configured in accordance with some embodiments of the present invention. The queue management system 100 includes a plurality of ticket machines 120a-z which may each be configured to manage a service queue for respective businesses A-Z, and may further include a queue server 130. The ticket machine 120a may, for example, manage the service queue for customers who are waiting to be seated at a restaurant business A. The ticket machines 120b-z may similarly manage the separate service queues for customers how are waiting to be seated at other restaurant businesses B-Z. Although the queue server 130 is shown as being separate from the ticket machines 120a-z for ease of description, it is not limited thereto, because the functionality of the queue server 130 may at least partially reside in one or more of the ticket machines 120a-z.

A person may operate a wireless terminal 110 to carry out a keyword search through the queue server 130 to identify businesses having electronically accessible queues. The keyword search may include the name of a business and/or business categories (e.g., restaurant, Chinese restaurant, etc.), and may further include a geographic region in which the search is to be conducted (e.g., Stockholm Sweden). The queue server 130 may function as an Internet searchable directory for businesses that allow electronic access to their service queues. The queue server may contain a searchable database that associates business names with service/product categories and addresses, and can further identify a Universal Resource Locator (URL) address or other identifier for businesses which can enable the wireless terminal 110 to connect to the ticket machine and associated queue for a selected business(es).

Communications between the wireless terminal 110 and the queue server 130 may be carried out using far-field wireless communications through a base station 140 and the Internet 150. The far-field wireless communications may be carried out using, for example, a cellular protocol, a WiMAX protocol (e.g., IEEE 802.16), and/or a High-Performance Radio Metropolitan Area Network (HIPERMAN ETSI standard) protocol. Thus, a person may search for and electronically access one or more queues operated by businesses while being remotely located to any of the businesses.

In response to a keyword search, the queue server 130 returns information that identifies one or more corresponding business queues, operated by the ticket machines 120a-z, for display on the wireless terminal 110. The person may then identify which, if any, of the business queues the person wants to enter and, in response to such identification, receives an electronic queue ticket from the associated ticket machine and which is stored in the wireless terminal 110. Upon arriving in the vicinity of the selected business, the queue ticket can be validated using a RF ID protocol, a Bluetooth protocol, and/or a WLAN protocol, or another near-field wireless communications protocol between the wireless terminal 110 and the ticket machine associated with the queue. The business is thereby notified that the person is proximately located to the business and is therefore available to receive services upon satisfying the queue.

Although FIG. 1 illustrates an exemplary queue management system, it will be understood that the present invention is not limited to such configurations, but is intended to encompass any configuration capable of carrying out the operations described herein.

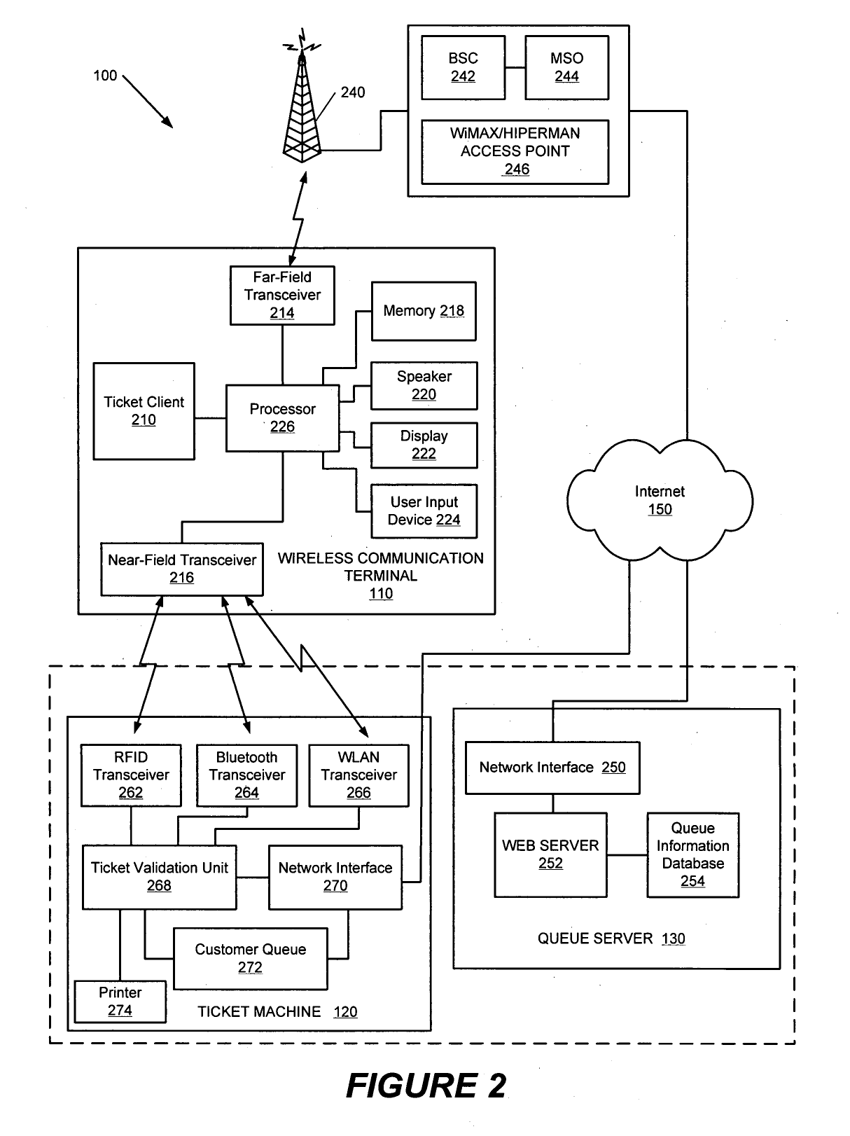

FIG. 2 is a block diagram that illustrates further detail of a portion of the queue management system 100 of FIG. 1 in accordance with some embodiments of the present invention. Referring to FIG. 2, the wireless terminal 110 may include a ticket client 210, a far-field transceiver 214, a near-field transceiver 216, a memory 218, a speaker 220, a display 222, and a user input device 224 which are operatively interconnected by a processor 226. The processor 226 is configured to carry out wireless communications functionality, such as conventional cellular phone functionality (e.g., telephone call generation and receipt, text/picture/video messaging, and/or phone book management).

The far-field transceiver 214 is configured to communicate with the queue server 130 over a wireless air interface with one or more RF transceiver base stations 240 using one or more far-field communication protocols such as, for example, Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, Universal Mobile Telecommunications System (UMTS), WiMAX, and/or HIPERMAN.

The base station 240 can be connected to cellular infrastructure that may include a base station controller 242 and a mobile switching office 244 to communicatively connect the wireless terminal 110 with the Internet 150. Alternatively or additionally, the base station 240 may be connected to a WiMAX/HIPERMAN access point 246 to communicatively connect the wireless terminal 110 with the Internet 150.

The near-field transceiver 216 is configured to communicate with the ticket machine 120 across a wireless air interface using one or more near-field communication protocols, such as, for example, RF ID, Bluetooth, and/or WLAN.

The queue server 130 may include a network interface 250, a WEB server 252, and a queue information database 254. The queue information database 254 functions as a searchable directory for businesses that allow electronic access to their service queues. The database 254 associates business names with service/product categories and addresses, and can further identify a Universal Resource Locator (URL) or other identifier which can enable the wireless terminal 110 to connect to the ticket machine and associated queue for a selected business.

An operator of the queue server 130 may maintain information for a business in the database 254 on a subscription fee basis (i.e., the business may pay the operator to have its associated searchable terms for an electronically accessible queue listed in the database 254).

The WEB server 252 is communicatively connected to the Internet through the network interface 250. The WEB server 252 receives search queries via the Internet 150 which are carried out by the database 254, and outputs the results of the search, via the Internet 150 and the base station 240, as WEB page commands (e.g., HTML, WAP) that can be displayed on the wireless terminal 110.

The ticket machine 120 may include a RF ID transceiver 262, a Bluetooth transceiver 264, and/or a WLAN transceiver 266 which provide near-field communications with the nearer-field transceiver 216 of the wireless terminal 110. The ticket machine 120 may further include a ticket validation unit 268, a network interface 270, a customer queue 272, and a printer 274. The network interface connects the ticket validation unit 268 with the queue server 130 via the Internet 150 or, as described above, the queue server 130 may be at least partially integrated within the ticket machine 120.

The ticket client 210 is configured to communicate with the queue server 130 via the far field transceiver 214 to search for electronically accessible queues, which, for example, is queue 272. The ticket client 210 is further configured to communicate with the ticket machine 120 via the far field transceiver 214 to obtain information on the queue 272, to enter into the queue 272, and to obtain an electronic queue ticket confirming entry into the queue 272. Upon becoming proximately located to one another, the ticket client 210 is further configured to communicate with the ticket machine 120 via the near-field transceiver 216 to validate the queue ticket and thereby enable access to services that are being regulated by the queue 272 upon the queue 272 being satisfied (i.e., movement of the ticket client identifier for the person to the top of the queue 272).

Although FIG. 2 illustrates an exemplary queue management system, it will be understood that the present invention is not limited to such configurations, but is intended to encompass any configuration capable of carrying out the operations described herein.

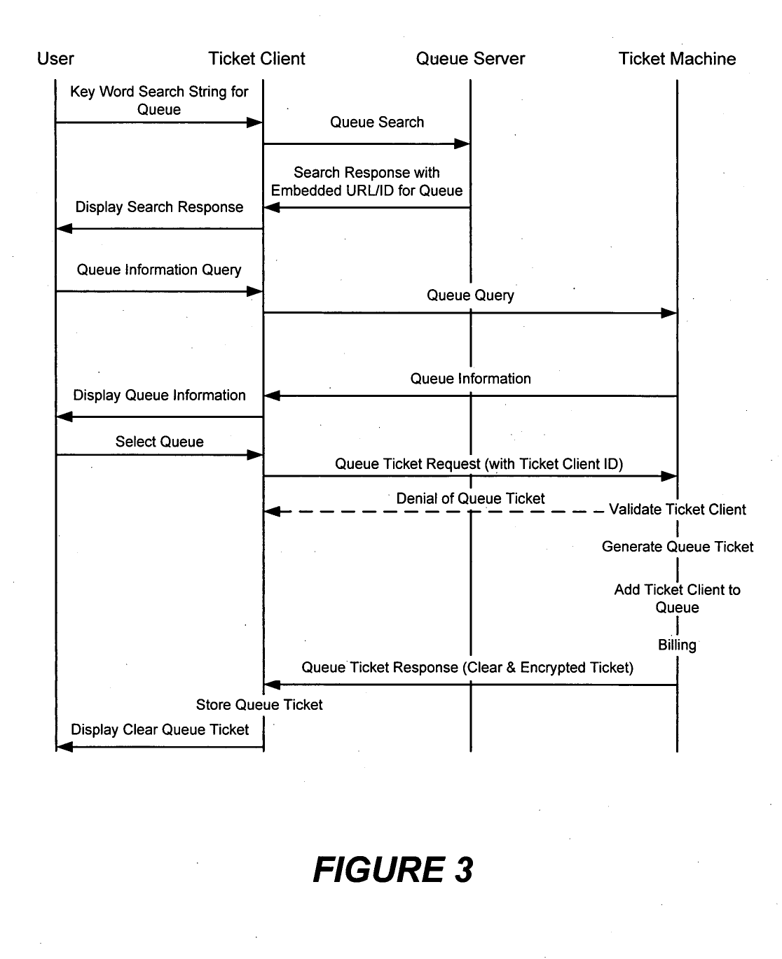

Various exemplary operations of the components of FIG. 2 will now be discussed with regard to FIGS. 3-7.

FIG. 3 is a message flow diagram that illustrates operations and methods for searching for an electronically accessible queue, entering the queue, and obtaining a queue ticket via the ticket client 210 on a wireless communication terminal 110 in accordance with some embodiments of the present invention. Referring to FIG. 3, a user may operate the wireless terminal 110 to input a keyword search string, via the user input device 224, into the ticket client 210. The ticket client 210 communicates a queue search to the queue server 130, via the far-field transceiver 214 and/or the near-field transceiver 216. The queue server 130 responds thereto by searching the queue information database 254 to identify what, if any, businesses have electronically accessible queues that satisfy the received keyword search string. For example, a keyword search string may identify one or more business names and/or business categories and may further identify an address and/or a geographic region (e.g., city, zip code, county, state).

The queue server 130 communicates a search response which identifies a corresponding business and provides a URL address and/or other identifier embedded therein which enables communication between the ticket client 210 and the ticket machine(s) 120 associated with the corresponding businesses. The ticket client 210 displays the search response on the display 222.

The user may request further information on the queues for one or more selected businesses, such as the present wait times for service through the queue and/or the projected wait times for a defined time/date. In response to the request, the ticket client 210 generates a queue information query which is communicated to one or more of the selected businesses using the URL address and/or other identifier which was embedded in the earlier search response from the queue server 130. The queue information query may be transmitted to the ticket machine 120 through the far-field transceiver 214, the base station 240, and the Internet 150 and/or it may be transmitted to the ticket machine 120 through the near-field transceiver 216. The ticket machine 120 communicates a queue information response to the ticket client 210, which is displayed to the user on the display 222.

In response to the displayed queue information, the user may request entry into a selected one of the business queues. Such entry is initiated by the ticket client 210 communicating a queue ticket request, which includes an identifier for the ticket client 210 (e.g., a computer generated identifier and/or a user defined identifier such as the user's name), to the ticket machine 120 corresponding to the selected business. The ticket machine 120 may validate the ticket client 210 by, for example, confirming that the ticket client 210, or the identifier provided with the queue ticket request, is not already entered into the queue 272 and/or is not already entered into a queue of another ticket machine which is associated with the same or another business (e.g., prevent a user from occupying more than one queue location for a business or a group of business that share queue information). If the ticket client 210 is determined to already occupy a position in the queue 272 or another queue, the ticket validation unit 268 may communicate a “denial of queue ticket” notice to the ticket client 210, thereby be notifying the user that the queue request has been denied.

When the ticket client 210 is validated, the ticket validation unit 268 adds the ticket client identifier to the queue 272, and generates an electronic queue ticket which it communicates to the ticket client 210 via far-field communications and/or near-field communications as part of a queue ticket response. The electronic queue ticket may include a clear portion (e.g. unencrypted text), which can be displayed on the display 222 of the wireless terminal 110, and an encrypted portion. The encrypted portion of the queue ticket may serve to prevent generation of fraudulent queue tickets by unauthorized persons. The queue ticket is stored in the wireless terminal 110, such as in the memory 218. The ticket validation unit 268 may charge the user a fee for electronically entering the queue provided by the ticket machine 120, and such fee may, for example, be added to the user's bill at the end of the associated transaction.

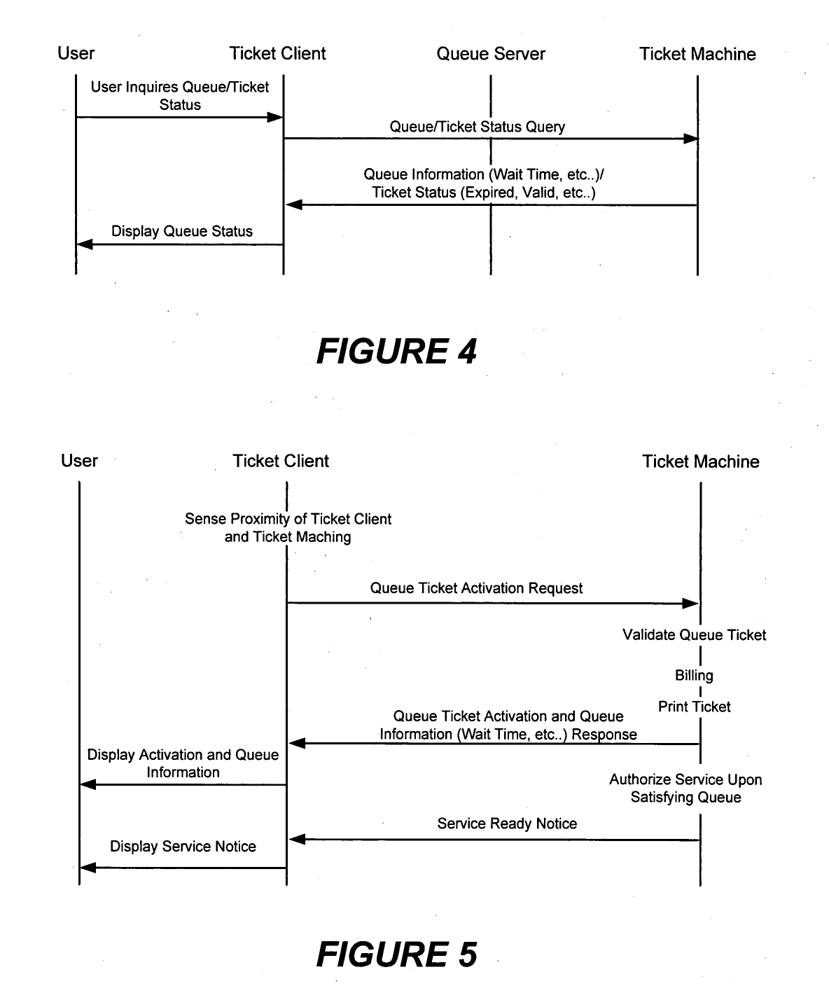

FIG. 4 is a message flow diagram that illustrates operations and methods for obtaining status information for the queue 272 via the ticket client 210 on the wireless terminal 110 in accordance with some embodiments of the present invention. After the user has obtained a queue ticket, the user may want to obtain updated information regarding the queue 272, such as user's position in the queue 272 and the projected time when the user will obtain service, and/or the status of the queue ticket, such as whether the queue ticket is valid or expired. The user may determine such information by causing the ticket client 210 to generate a queue/ticket status query which is communicated through the far-field transceiver 214 and/or the near-field transceiver 216 to the ticket validation unit 268 of the ticket machine 120. The ticket validation unit 268 sends a response to the ticket client 210 with the requested queue/ticket information. The queue/ticket information is then displayed by the ticket client 210 on the display 222 of the wireless terminal 110.

FIG. 5 is a message flow diagram that illustrates operations and methods for activating a queue ticket via the ticket client 210 on the wireless terminal 110 and authorizing service upon satisfying the queue 272 in accordance with some embodiments of the present invention. Upon arriving in the vicinity of the selected business, the queue ticket can be validated so that the business can thereby notified that the person is proximately located to the business and is therefore available to receive services upon satisfying the queue. The proximity of the ticket client 210 having the queue ticket may be detected by the ticket machine 120 through the Bluetooth transceiver 264 and/or the WLAN transceiver 266 using a device discovery protocol to detect the presence of the near-field transceiver 216 of the wireless terminal 110. Alternatively or additionally, the user may swipe the wireless terminal 110 in close proximity to the RF ID transceiver 262 to activate the queue ticket, or otherwise operate the ticket client 210 to provide such notice to the ticket machine 120.

Upon sensing the proximity of the wireless terminal 110, having the queue ticket, to the ticket machine 120, the ticket client 210 communicates a queue ticket activation request, which includes the queue ticket retrieved from the memory 218, to the ticket validation unit 268 of the ticket machine 120. The ticket validation unit 268 validates the queue ticket, such as by decrypting the encrypted portion of the key ticket and confirming that the decryption was successful. In response to validation of the queue ticket, the user may be charged a fee, such as was described above, and a paper ticket may be printed by the printer 274. The ticket validation unit 268 may communicate a queue ticket activation response to the ticket client 210 which may include updated queue information, such as the current wait time and the expected time of service for the user. The queue ticket activation response may be displayed on the display 222 of the wireless terminal 110. In response to the queue 272 becoming satisfied, such as by the ticket client position rising to at least a threshold level in the queue 272 (e.g., top of the key 272), the ticket validation unit 268 may communicate a service ready notice to the ticket client 210, which may be displayed on the display 222 of the wireless terminal 110. The user may thereby be notified when is the user's turn to receive service.

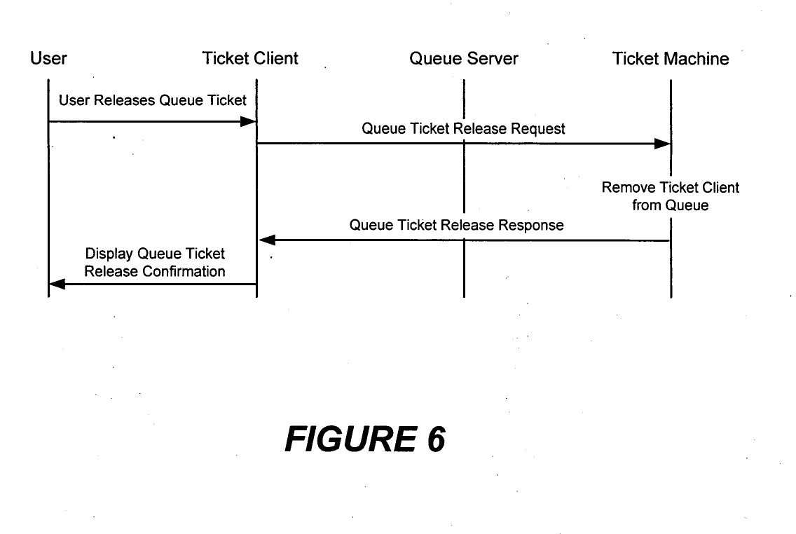

After the user has obtained a queue ticket, the user may subsequently decide that the associated services are no longer desired and may therefore want to remove the user's identity from the queue 272. FIG. 6 is a message flow diagram that illustrates operations and methods for releasing a queue ticket via the ticket client 210 on the wireless terminal 110 in accordance with some embodiments of the present invention. Referring to FIG. 6, the user may operate the ticket client 210 to generate a queue ticket release request, which is communicated through the far-field transceiver 214 and/or the near-field transceiver 216 to the ticket validation unit 268 of the ticket machine 120. The ticket validation unit 268 removes the ticket client from the queue 272, and communicates a queue ticket release response back to the ticket client 210. The release response may then be displayed on the display 222 of the wireless terminal 110 to provide confirmation to the user that the user has been removed from the queue 272.

The message flow diagrams of FIGS. 3-6 illustrate exemplary operations and methods for carrying out the functionality described herein. It is to be understood however, that the associated messages and operations may occur out of the order noted in FIGS. 3-6. For example, two messages/operations shown in succession may, in fact, be carried out substantially concurrently or may sometimes be carried out in the reverse order, depending on the functionality involved.

Many variations and modifications can be made to the embodiments without substantially departing from the principles of the present invention. All such variations and modifications are intended to be included herein within the scope of the present invention, as set forth in the following claims.

What is claimed is:

1. A method comprising:
obtaining, via a wireless communications terminal from a ticket machine, a queue ticket indicating entry of a ticket client into a queue associated with the ticket machine;
storing the queue ticket in the wireless communications terminal;
validating the queue ticket stored in the wireless communications terminal via a near-field communications protocol wireless interface between the wireless communications terminal and the ticket machine; and
authorizing service for the ticket client in response to validation of the queue ticket and movement of the ticket client to a threshold level within the queue.

2. The method of claim 1, wherein obtaining a queue ticket indicating entry of a ticket client into a queue comprises:
communicating a queue request from the wireless communications terminal through the Internet to the ticket machine;
entering the ticket client into the queue; and
communicating the queue ticket from the ticket machine through the Internet to the wireless communications terminal.

3. The method of claim 2, wherein the queue request is communicated from the wireless communications terminal to the Internet via a far-field communications protocol air interface.

4. The method of claim 3, wherein the queue request is communicated from the wireless communications terminal to the Internet via a cellular protocol air interface, a WiMAX communications protocol air interface, and/or a HIPERMAN communications protocol air interface.

5. The method of claim 2, further comprising:
determining how many entries for the ticket client are present in the queue; and
communicating a denial of queue ticket response from the ticket machine to the wireless communications terminal in response to the determined number of entries exceeding a threshold number.

6. The method of claim 5, further comprising:
communicating a queue ticket release command from the wireless communications terminal to the ticket machine; and
removing the ticket client from the queue in response to the queue ticket release command.

7. The method of claim 1, further comprising:
generating a queue search query from the wireless communications terminal through the Internet to a queue server; and
communicating a queue response from the queue server through the Internet to the wireless communications terminal,
wherein communication of the queue request from the wireless communications terminal to the ticket machine is carried out based on information contained in the queue response from the queue server.

8. The method of claim 7, wherein:
the queue search query generated from the wireless communications terminal identifies a business name and/or a business category; and
the queue response communicated from the queue server contains information that identifies what queues, if any, are associated with the business name and/or the business category identified by the queue search query.

9. The method of claim 1, wherein validating the queue ticket comprises:
communicating the queue ticket from the wireless communications terminal to the ticket machine via a radio frequency identification (RF ID) communications protocol air interface, a Bluetooth communications protocol air interface, and/or a wireless local area network (WLAN) communications protocol air interface; and
validating the received queue ticket at the ticket machine.

10. The method of claim 1, wherein:
obtaining a queue ticket comprises communicating an at least partially encrypted queue ticket from the ticket machine to the wireless communications terminal; and
validating the queue ticket comprises communicating the queue ticket from the wireless communications terminal to the ticket machine via the near-field communications protocol air interface, decrypting the encrypted portion of the queue ticket at the ticket machine, and determining whether the queue ticket is valid in response to the decryption.

11. An electronic device comprising:
a near-field communications protocol transceiver that is configured to communicate via a near-field communications protocol with one or more communication devices; and
a ticket client that is configured to store a queue ticket obtained from a ticket machine, where the queue ticket indicates entry of the ticket client into a queue associated with the ticket machine, and configured to communicate the queue ticket to the ticket machine through the near-field communications protocol transceiver.

12. The electronic device of claim 11, further comprising:
a far-field communications protocol transceiver that is configured to communicate via a far-field communications protocol to an Internet service provider connected to the ticket machine,
wherein the ticket client is further configured to transmit a queue request through the far-field communications protocol transceiver and the Internet to the ticket machine, and to receive the queue ticket from the ticket machine through the far-field communications protocol transceiver.

13. The electronic device of claim 12, wherein:
the near-field communications protocol transceiver is configured to communicate according to a radio frequency identification (RF ID) communications protocol, a Bluetooth communications protocol, and/or a wireless local area network (WLAN) communications protocol; and
the far-field communications protocol transceiver is configured to communicate according to a cellular protocol, a WiMAX communications protocol, and/or a HIPERMAN communications protocol.

14. The electronic device of claim 13, wherein:
the near-field communications protocol transceiver is further configured to detect presence of the ticket client within communication range thereof; and
the ticket client is further configured to communicate the queue ticket to the ticket machine via the near-field communications protocol transceiver in response to detecting presence of the ticket client.

15. The electronic device of claim 11, further comprising a display device, wherein:
the ticket client is further configured to generate a queue search query that identifies a business name and/or a business category and which is transmitted through the far-field communications protocol transceiver to a queue server, configured to receive a queue response from the queue server via the far-field communications protocol transceiver, the queue response identifying which queues, if any, are associated with the business name and/or the business category identified by the queue search query, and configured to display information that is indicative of the queues identified by the queue response.

16. The electronic device of claim 15, wherein the ticket client is further configured to detect a user selection of one of the queues identified by the queue response, and to generate a queue request that identifies the user selected queue and which is transmitted through the far-field communications protocol transceiver to the ticket machine.

17. A queue management system comprising:
a ticket machine that is configured to enter a ticket client into a queue, to communicate a queue ticket across the Internet to the ticket client hosted on a wireless terminal indicating entry of the ticket client into the queue, to validate the queue ticket stored in the wireless communications terminal via a near-field communications protocol air interface between the wireless communications terminal and the ticket machine, and to authorize service associated with the ticket client in response to validation of the queue ticket and movement of the ticket client to a threshold level within the queue.

18. The queue management system of claim 17, further comprising:
a queue server that is configured to receive from the ticket client via the Internet a queue search query that identifies a business name and/or a business category, configured to communication a queue response to the ticket client via the Internet that identifies what queues, if any, are associated with the business name and/or the business category identified by the queue search query, wherein the queue response is used by the ticket client to generate a queue request that identifies one of the queues where entry is requested.

19. The queue management system of claim 17, wherein:
the ticket machine is further configured to encrypt at least a portion of the queue ticket communicated to the ticket client, and to validate the queue ticket received back from the ticket client by decrypting the encrypted portion of the queue ticket and determining whether the queue ticket is valid in response to the decryption.

20. The queue management system of claim 17, wherein the ticket machine comprises:
a near-field communications protocol transceiver that is configured to receive the queue ticket from the ticket client hosted on the wireless communication device via a radio frequency identification (RF ID) communications protocol wireless interface, a Bluetooth communications protocol wireless interface, and/or a wireless local area network (WLAN) communications protocol interface.
